(19) United States
(12) Patent Application Publication
(10) Pub. No.: US 2023/0356230 A1
(43) Pub. Date: Nov. 9, 2023

(54) REAGENT CARTRIDGES AND RELATED SYSTEMS AND METHODS FOR CONTROLLING REAGENT TEMPERATURE

(71) Applicants: ILLUMINA, INC., San Diego, CA (US); ILLUMINA CAMBRIDGE LIMITED, Cambridge (GB)

(72) Inventors: Elisabet Rosas, El Cerrito, CA (US); Philip Balding, Sawston (GB); Cyril Delattre, Lyon (FR); Jacqueline Weir, Cambridge (GB); Ramir Vega, San Francisco, CA (US); Jennifer Foley, San Diego, CA (US); Paul Sangiorgio, San Diego, CA (US); Darren Segale, San Diego, CA (US); Pietro Gatti Lafranconi, Cambridge (GB); Tarun Khurana, Fremont, CA (US); Jacob Ruden, San Diego, CA (US); Craig Hetherington, Foster City, CA (US)

(21) Appl. No.: 18/002,448

(22) PCT Filed: Mar. 2, 2022
(86) PCT No.: PCT/US22/18444

§ 371 Date: Dec. 19, 2022

Related U.S. Application Data
(60) Provisional application No. 63/156,047, filed on Mar. 3, 2021.

(51) Int. Cl. B01L 7/00

(52) U.S. Cl. CPC B01L 7/52; B01L 2200/147; B01L 2300/1861; B01L 2300/1894

(57) ABSTRACT

Reagent cartridges and related systems and methods for controlling reagent temperature are disclosed. In accordance with an implementation, an apparatus includes a system and a reagent cartridge. The system includes a reagent cartridge receptacle, a non-contact temperature controller, a processor operatively coupled to the temperature controller. The reagent cartridge is receivable within the reagent cartridge receptacle and includes a flow cell assembly, a plurality of reagent reservoirs, and a manifold assembly. The manifold assembly includes a common fluidic line and a plurality of reagent fluidic lines. Each of the plurality of reagent fluidic lines is adapted to be fluidically coupled to a corresponding reagent reservoir and selectively couplable to the common fluidic line. The processor is to cause the temperature controller to change a temperature of at least one of the common fluidic line or one or more of the reagent fluidic lines.

### RELATED APPLICATION

This application claims the benefit of and priority to U.S. Provisional Patent Application No. 63/156,047, filed Mar. 3, 2021, the content of which is incorporated by reference herein in its entireties and for all purposes.

### BACKGROUND

Sequencing platforms may include valves and pumps. The valves and pumps may be used to perform various fluidic operations.

### SUMMARY

Shortcomings of the prior art can be overcome and benefits as described later in this disclosure can be achieved through the provision of reagent cartridges and related systems and methods for controlling reagent temperature. Various implementations of the apparatus and methods are described below, and the apparatus and methods, including and excluding the additional implementations enumerated below, in any combination (provided these combinations are not inconsistent), may overcome these shortcomings and achieve the benefits described herein.

In accordance with a first implementation, an apparatus includes a system and a reagent cartridge. The system includes a reagent cartridge receptacle, a non-contact temperature controller, and a processor operatively coupled to the temperature controller. The reagent cartridge is receivable within the reagent cartridge receptacle and includes a flow cell assembly, a plurality of reagent reservoirs, and a manifold assembly. The manifold assembly includes a common fluidic line and a plurality of reagent fluidic lines. Each of the plurality of reagent fluidic lines is adapted to be fluidically coupled to a corresponding reagent reservoir and selectively couplable to the common fluidic line. The processor is to cause the temperature controller to change a temperature of at least one of the common fluidic line or one or more of the reagent fluidic lines.

In accordance with a second implementation, an apparatus includes a reagent cartridge including a plurality of reagent reservoirs, a temperature controller, and a manifold assembly. The manifold assembly includes a common fluidic line and a plurality of reagent fluidic lines. Each of the plurality of reagent fluidic lines is adapted to be fluidically coupled to a corresponding reagent reservoir. The temperature controller is positioned to change a temperature of the common fluidic line.

In accordance with a third implementation, a method includes flowing reagent through at least one of a reagent fluidic line or a common fluidic line and toward a flow cell assembly and determining a temperature associated with the reagent fluidic line or the common fluidic line. The method also includes comparing the determined temperature to a reference temperature and, in response to the determined temperature being outside of a threshold of the reference temperature, changing a temperature of the reagent as the reagent is flowing through the at least one of the reagent fluidic line or the common fluidic line.

In accordance with a fourth implementation, an apparatus includes a system and a reagent cartridge. The system includes a reagent cartridge receptacle, a non-contact heater, and a processor operatively coupled to the heater. The reagent cartridge is receivable within the reagent cartridge receptacle. The reagent cartridge includes a flow cell assembly, a plurality of reagent reservoirs, and a manifold assembly. The manifold assembly includes a common fluidic line and a plurality of reagent fluidic lines. Each of the plurality of reagent fluidic lines are adapted to be fluidically coupled to a corresponding reagent reservoir and selectively couplable to the common fluidic line. The processor is to cause the heater to change a temperature of at least one of the common fluidic line or one or more of the reagent fluidic lines.

In accordance with a fifth implementation, an apparatus includes a temperature controller and a reagent cartridge includes a reagent reservoir and a fluidic line fluidically coupled to the reagent reservoir. The temperature controller is positioned to change a temperature of the fluidic line.

In accordance with a sixth implementation, an apparatus includes a system including a flow cell support, an imaging system, a non-contact heater, and a processor. The flow cell support is to receive a flow cell and the imaging system includes an imaging device, an optical assembly, and a light source assembly to emit a beam that is received by the optical assembly. The processor is operatively coupled to the non-contact heater and the processor is to cause the non-contact heater to change a temperature of the flow cell.

In accordance with a seventh implementation, a method includes flowing reagent through a fluidic line toward a flow cell on a flow cell support and receiving the regent within the flow cell. The method also includes heating the reagent within the flow cell using a non-contact heater and controlling a temperature of the flow cell support using a temperature control device.

In further accordance with the foregoing first, second, third, fourth, fifth, sixth, and/or seventh implementations, an apparatus and/or method may further include or comprise any one or more of the following:

In an implementation, the reagent cartridge includes a body having a window to enable the temperature controller to change a temperature of at least one of the common fluidic line or one or more of the reagent fluidic lines.

In another implementation, the reagent cartridge further includes a waste reservoir having a second window that is aligned with the window of the body.

In another implementation, the temperature controller is spaced from the manifold assembly.

In another implementation, the temperature controller includes a temperature sensor positioned to determine a temperature associated with at least one of the common fluidic line or one or more of the reagent fluidic lines and, the processor is configured to compare the determined temperature to a reference temperature. In response to the determined temperature being outside of a threshold of the reference temperature, the processor causes the temperature controller to change a temperature of at least one of the common fluidic line or one or more of the reagent fluidic lines.

In another implementation, the temperature controller includes a heater and a temperature sensor. The heater is positioned to heat at least one of the common fluidic line or one or more of the reagent fluidic lines and the temperature sensor is positioned to determine a temperature associated with at least one of the common fluidic line or one or more of the reagent fluidic lines. The processor is adapted to control the heater based on the temperature determined by the temperature sensor.

In another implementation, the heater includes a non-contact heater.

In another implementation, the heater includes an infrared heater.

In another implementation, the heater includes a LED heater.

In another implementation, the apparatus includes an orifice positioned to direct a beam emitted by the LED heater toward the at least one of the common fluidic line or one or more of the reagent fluidic lines.

In another implementation, the temperature controller further includes a cooler.

In another implementation, the cooler includes a nozzle, a valve, and an air source fluidically coupled to the nozzle by the valve.

In another implementation, the manifold assembly includes a body and a membrane coupled to a surface of the body. The common fluidic line is defined between the membrane and the body. The body is on a first side of the common fluidic line and the membrane is on a second side of the common fluidic line.

In another implementation, the temperature controller is positioned on at least one of the first side or the second side of the common fluidic line to change a temperature of the common fluidic line.

In another implementation, the reagent fluidic lines of the manifold assembly are defined between the membrane and the body. Each of the reagent fluidic lines includes a membrane valve and a corresponding actuator disposed within the manifold assembly adapted to move the opposing membrane away from a valve seat of the corresponding membrane valve.

In another implementation, the temperature controller is positioned on at least one of the first side or the second side of the common fluidic line to change a temperature of the corresponding reagent fluidic line.

In another implementation, the temperature controller is coupled to a surface of the reagent cartridge.

In another implementation, the temperature controller is coupled to the surface of the cartridge using adhesive.

In another implementation, the temperature controller includes a heater and a temperature sensor. The heater is positioned to heat the common fluidic line and the temperature sensor is positioned to determine a temperature associated with the common fluidic line.

In another implementation, the heater includes a flexible heater and the temperature sensor includes a thermocouple.

In another implementation, changing the temperature of the reagent includes heating the at least one of the reagent fluidic line or the common fluidic line.

In another implementation, heating the at least one of the reagent fluidic line or the common fluidic line includes heating the at least one of the reagent fluidic line or the common fluidic line using at least one of a flexible heater, an infrared heater, or a LED heater.

In another implementation, changing the temperature of the at least one of the reagent fluidic line or the common fluidic line includes cooling the at least one of the reagent fluidic line or the common fluidic line.

In another implementation, cooling the at least one of the reagent fluidic line or the common fluidic line includes flowing compressed air toward the at least one of the reagent fluidic line or the common fluidic line.

In another implementation, heating the at least one of the reagent fluidic line or the common fluidic line includes heating the common fluidic line and substantially not heating the reagent fluidic line.

In another implementation, the heating includes heating using a flexible heater.

In another implementation, the heating includes heating using a flexible heater, or an infrared heater.

In another implementation, the heating includes heating using a LED heater.

In another implementation, the reagent cartridge further includes a temperature sensor.

In another implementation, the temperature sensor is positioned to determine a temperature associated with at least one of the common fluidic line or one or more of the reagent fluidic lines.

In another implementation, the processor compares the determined temperature to a reference temperature, and in response to the determined temperature being outside of a threshold of the reference temperature, the processor causes the heater to change a temperature of at least one of the common fluidic line or one or more of the reagent fluidic lines.

In another implementation, the system further includes a temperature sensor operable to detect a temperature of at least one of the common fluidic line or one or more of the reagent fluidic lines of the reagent cartridge.

In another implementation, the apparatus includes a temperature control device for the flow cell support.

In another implementation, the temperature control device comprises a thermoelectric cooler.

In another implementation, the non-contact heater includes a LED heater.

In another implementation, the non-contact heater is carried by the imaging system.

In another implementation, the imaging system includes the non-contact heater.

In another implementation, the non-contact heater emits a beam that is received by the optical assembly.

In another implementation, the optical assembly includes a directional optical element and a focusing objective and the directional optical element redirects the beam of the non-contact heater to the focusing objective.

In another implementation, heating the reagent within the flow cell using the non-contact heater includes the non-contact heater emitting a beam and directing the beam to the flow cell.

In another implementation, heating the reagent within the flow cell using the non-contact heater includes the non-contact heater emitting a beam, redirecting the beam to an optical assembly, and projecting the redirected beam onto the flow cell.

In another implementation, heating the reagent within the flow cell using the non-contact heater includes the non-contact heater emitting a beam, receiving the beam at an optical assembly, and projecting the beam onto the flow cell.

In another implementation, the temperature control device includes a thermoelectric cooler.

It should be appreciated that all combinations of the foregoing concepts and additional concepts discussed in greater detail below (provided such concepts are not mutually inconsistent) are contemplated as being part of the subject matter disclosed herein and/or may be combined to achieve the particular benefits of a particular aspect. In particular, all combinations of claimed subject matter appearing at the end of this disclosure are contemplated as being part of the subject matter disclosed herein.

### BRIEF DESCRIPTION OF THE DRAWINGS

FIG. 1 illustrates a schematic diagram of an implementation of a system in accordance with the teachings of this disclosure.

FIG. 2 is a detailed cross-sectional view of a portion of a manifold assembly and a heater that can be used to implement the manifold assembly of the reagent cartridge of FIG. 1 and the heater of the system of FIG. 1.

FIG. 3 is another detailed cross-sectional view of the portion of the manifold assembly and the heater of FIG. 2, with the heater being positioned on the second side of the manifold assembly as opposed to being positioned on the first side of the manifold assembly.

FIG. 4 is a detailed cross-sectional view of a portion of another manifold assembly that can be used to implement the manifold assembly of FIG. 1 and heaters positioned on both sides of the reagent fluidic line of the manifold assembly.

FIG. 5 is a top plan view of another reagent cartridge that can be used to implement the reagent cartridge of FIG. 1.

FIG. 6 is a top plan view of the reagent cartridge of FIG. 5 that excludes the body of the reagent cartridge to more clearly illustrate the waste reservoir.

FIG. 7 is a schematic diagram of another reagent cartridge that can be used with the system of FIG. 1.

FIG. 8 illustrates a flowchart for a method of controlling a temperature of reagent flowing through a fluidic line using the system of FIG. 1 or any of the disclosed implementations.

FIG. 9 illustrates a schematic diagram of an example implementation of a system in accordance with teachings of the disclosure.

FIG. 10 illustrates a schematic representation of an example imaging system and a non-contact heater that can be used to implement the imaging system and the non-contact heater of FIG. 9.

FIG. 11 illustrates a schematic representation of an example imaging system and a non-contact heater that can be used to implement the imaging system and the non-contact heater of FIG. 9.

FIG. 12 illustrates a schematic representation of an example imaging system and a non-contact heater that can be used to implement the imaging system and the non-contact heater of FIG. 9

FIG. 13 illustrates a flowchart for a method of controlling a temperature of reagent and/or of the flow cell using the system of FIG. 9 or any of the disclosed implementations.

### DETAILED DESCRIPTION

Although the following text discloses a detailed description of implementations of methods, apparatuses and/or articles of manufacture, it should be understood that the legal scope of the property right is defined by the words of the claims set forth at the end of this patent. Accordingly, the following detailed description is to be construed as examples only and does not describe every possible implementation, as describing every possible implementation would be impractical, if not impossible. Numerous alternative implementations could be implemented, using either current technology or technology developed after the filing date of this patent. It is envisioned that such alternative implementations would still fall within the scope of the claims.

Chemical reactions performed within a flow cell may be more efficient when the flow cell is at a threshold temperature (e.g., 60° C.). Reagent used during these reactions may be stored below the threshold temperature however, such as at room temperature or below room temperature. The temperature of the flow cell may thus decrease for an equilibration time when the reagent flows into the flow cell. Unfortunately, during the equilibration time when the temperature of the flow cell is below the threshold temperature, the efficiency of the chemical reactions performed within the flow cell may be reduced, an amount of reagent used during the chemical reactions may be increased, and an amount of time to perform the associated cycle may be increased.

At least one aspect of this disclosure is directed toward reagent cartridges and related systems that enable cycle times to be significantly reduced while also reducing the associated reagent consumption costs. A sequencing run as such may be performed in approximately 3.75 hours less (approximately 35 seconds per cycle) than some run times that take between 11 hours and 15 hours to complete using the disclosed implementations. Thus, a sequencing run can be completed in approximately 8 hours, less than 8 hours, or approximately 6 hours (down from 11-15 hours) using the disclosed implementations. A single shift for an employee(s) may prepare for the run, perform the run, and clean up after the run by performing the sequencing run in less than 8 hours. The disclosed implementations preheat the reagent prior to the reagent entering the flow cell to do so.

The reagent cartridge includes a manifold assembly having a common fluidic line and a plurality of reagent fluidic lines in some implementations and the system includes a temperature controller that is positioned to change a temperature of at least one of the common fluidic line or one or more of the reagent fluidic lines. The reagent entering the flow cell does not substantially decrease the temperature of the flow cell from the threshold temperature by increasing the temperature of the fluidic line(s) and, thus, the equilibration time is reduced for the flow cell to again be at the threshold temperature.

A body of the reagent cartridge may include a window to enable the temperature controller to change the temperature of the corresponding fluidic line in some implementations. The waste reservoir may also have a window that is aligned with the window of the body of the reagent cartridge in implementations where the reagent cartridge includes the waste reservoir and the waste reservoir is positioned between temperature controller and the corresponding fluidic line.

The temperature controller may include a heater that is used to heat the corresponding fluidic line and a temperature sensor that is used to determine a temperature associated with the fluidic line regardless of how the fluidic line is accessed by the temperature controller. The temperature controller also includes a cooler that is used during some operations (e.g., imaging) to reduce the temperature of the reagent entering the flow cell. The cooler may include a compressed air source that flows compressed air toward and/or over the fluidic line. Different types of coolers may be used, however.

While the above implementation discloses the temperature controller as being part of the system and not part of the reagent cartridge (e.g., the disposable), in other implementations, the reagent cartridge may include the temperature controller. The temperature controller may be coupled at the corresponding fluidic line, the manifold assembly, an exterior surface of the body, or otherwise carried by the reagent cartridge in such implementations.

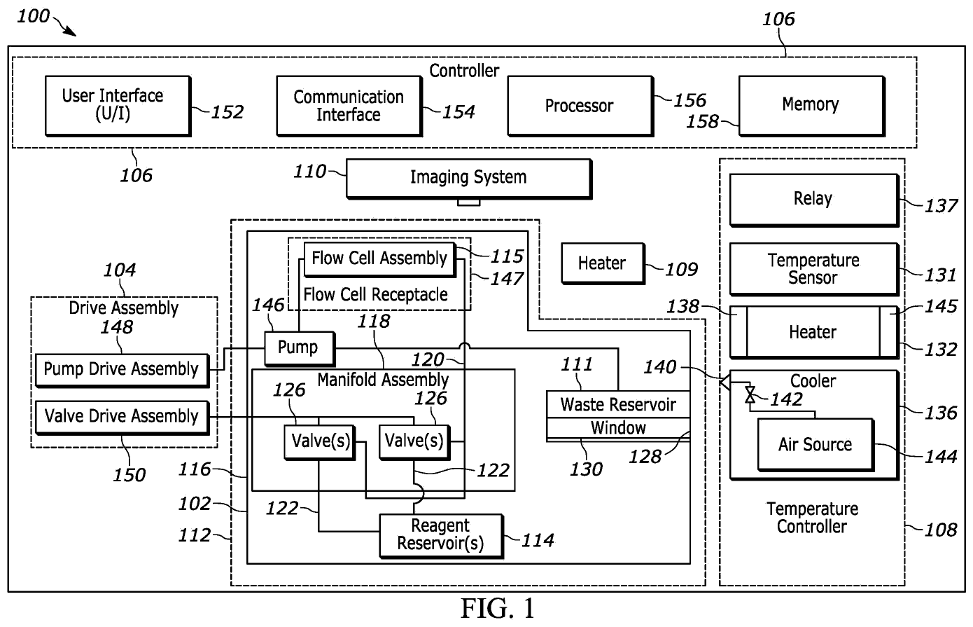

FIG. 1 illustrates a schematic diagram of an implementation of a system 100 in accordance with the teachings of this disclosure. The system 100 can be used to perform an analysis on one or more samples of interest. The sample may include one or more DNA clusters that have been linearized to form a single stranded DNA (sstDNA). The system 100 receives a reagent cartridge 102 in the implementation shown and includes, in part, a drive assembly 104, a controller 106, a contactless temperature controller 108, a heater 109, and an imaging system 110. The controller 106 is electrically and/or communicatively coupled to the drive assembly 104, the temperature controller 108, the heater 109, and the imaging system 110 and causes the drive assembly 104, the temperature controller 108, the heater 109, and the imaging system 110 to perform various functions as disclosed herein.

The reagent cartridge 102 carries the sample of interest. The drive assembly 104 interfaces with the reagent cartridge 102 to flow one or more liquid reagents (e.g., A, T, G, C nucleotides) through the reagent cartridge 102 that interact with the sample.

A reversible terminator is attached to the reagent to allow a single nucleotide to be incorporated onto a growing DNA strand in an implementation. One or more of the nucleotides has a unique fluorescent label that emits a color when excited in some such implementations. The color (or absence thereof) is used to detect the corresponding nucleotide. The imaging system 110 excites one or more of the identifiable labels (e.g., a fluorescent label) in the implementation shown and thereafter obtains image data for the identifiable labels. The labels may be excited by incident light and/or a laser and the image data may include one or more colors emitted by the respective labels in response to the excitation. The image data (e.g., detection data) may be analyzed by the system 100. The imaging system 110 may be a fluorescence spectrophotometer including an objective lens and/or a solid-state imaging device. The solid-state imaging device may include a charge coupled device (CCD) and/or a complementary metal oxide semicondusctor (CMOS).

After the image data is obtained, the drive assembly 104 interfaces with the reagent cartridge 102 to flow another reaction component (e.g., a reagent) through the reagent cartridge 102 and a flow cell assembly 115 including a flow cell to cleave the label/terminators and thereafter be received by a waste reservoir 111 and/or otherwise exhausted by the reagent cartridge 102. As used herein, a “flow cell” can include a device having a lid extending over a reaction structure to form a flow channel therebetween that is in communication with a plurality of reaction sites of the reaction structure. Some flow cells may also include a detection device that detects designated reactions that occur at or proximate to the reaction sites. The reaction component performs a flushing operation that chemically cleaves the fluorescent label and the reversible terminator from the sstDNA. The sstDNA is then ready for another cycle. The waste reservoir 111 may be between the manifold assembly 118 and the temperature controller 108. The waste reservoir 111 may be in a different location, may be sized differently, and/or the system 100 may alternatively include the waste reservoir 111, however. Other components such as a reagent well(s) may be positioned between the manifold assembly 118 and the temperature controller 108 in some implementations and, thus, a corresponding window may be provided to allow access between the manifold assembly 118 and the temperature controller 108.

Referring to the reagent cartridge 102, in the implementation shown, the reagent cartridge 102 is receivable within a cartridge receptacle 112 of the system 100 and includes reagent reservoirs 114, a body 116, and a manifold assembly 118 including a common fluidic line 120 and a plurality of reagent fluidic lines 122. The reagent fluidic lines 122 are adapted to be fluidically coupled to a corresponding reagent reservoir 114 and selectively couplable to the common fluidic line 120.

The body 116 may comprise or be formed of solid plastic using injection molding techniques and/or additive manufacturing techniques. The reagent reservoirs 114 are integrally formed with the body 116 in some implementations. The reagent reservoirs 114 are separately formed and coupled to the body 116 in other implementations. The reagent reservoirs 114 and/or the reagent cartridge 102 may include polypropylene and/or cyclic olefin copolymer (COC) with an over molded Santoprene thermoplastic elastomer (TPE) or another thermoplastic elastomer. Other materials may prove suitable for the reagent reservoirs 114 and/or the reagent cartridge 102, however.

The manifold assembly 118 is also shown including valves 126 that may be selectively actuatable to control the flow of fluid between the reagent fluidic lines 122 and the common fluidic line 120. One or more of the valves 126 may be implemented by a valve manifold, a rotary valve, a pinch valve, a flat valve, a solenoid valve, a reed valve, a check valve, a piezo valve, etc. The reagent cartridge 102 and/or the system 100 may include the valve(s) 126 if a rotary valve is used.

The heater 109 interfaces with the flow cell assembly 115 in operation and controls its temperature during one or more operations of the system 100 and/or an analysis taking place. The controller 106 is configured to cause the temperature controller 108 to change a temperature of at least one of the common fluidic line 120 or one or more of the reagent fluidic lines 122. The temperature controller 108 may change the temperature by applying heat or cold to the fluidic line(s) 120 and/or 122, for example. Heating the fluidic line(s) 120 and/or 122 and, thus, the reagent flowing through the fluidic line 120 and/or 122 prior to the reagent entering the flow cell assembly 115 advantageously allows a temperature of the flow cell assembly 115 to not decrease as much when the reagent enters the flow cell assembly 115 or at least decreases the possible duration for which a temperature of the flow cell assembly 115 falls below a threshold temperature as compared to when the reagent entering the flow cell assembly 115 has not been heated or is below the temperature of the flow cell assembly 115.

Still referring to the reagent cartridge 102, the body 116 defines a window 128 that enables the temperature controller 108 to change a temperature of at least one of the common fluidic line 120 or one or more of the reagent fluidic lines 122 in the implementation shown. The waste reservoir 111 also includes a window 130 that is aligned with the window 128 of the body 116. The windows 128, 130 may be rectangular and formed as through holes that allow access through the body 116 and the waste reservoir 111 and to one or more of the fluidic lines 120, 122. The windows 128, 130 are positioned over at least a portion of the common fluidic line 120 in some implementations. The common fluidic line 120 may have a length of approximately 20 millimeters (mm). The windows 128, 130 may not be positioned over the reagent fluidic lines 122 and/or the reagent reservoirs 114 however to deter other portions of the reagent cartridge 102 from being heated when the common fluidic line 120 is being heated. By selectively not heating some areas of the reagent cartridge 102, the reagent within the reagent reservoir 114 and/or the reagent fluidic line 122 may remain at room temperature or a temperature lower than that of the flow cell assembly 127, if desired, prior to use and prior to the reagent flowing through the heated common fluidic line 120, for example. Not heating reagent within the reagent reservoir 114 may be advantageous when there are multiple different reagent reservoirs with different reagents, some of which are more intolerant to heat (at least before use) than others. While the waste reservoir 111 is shown carried by the reagent cartridge 102 and disposed between the one or more of the fluidic lines 120 and the temperature controller 108, the waste reservoir 111 may be a different shape and/or in a location that allows a line of sight between the temperature controller 108 and the fluidic line 120, 122 without the window 130 through the waste reservoir 111 being provided in other implementations.

Referring to the temperature controller 108, the temperature controller 108 is spaced from the manifold assembly 118 and includes a temperature sensor 131, a heater 132, and a cooler 136 in the implementation shown. As set forth herein, the phrase “spaced from the manifold assembly” means that a gap exists between the temperature controller 108 and the manifold assembly 118. Said another way, the temperature controller 108 and the manifold assembly 118 are not directly physically connected by structure, wire(s), or other physical components (e.g., they physically are de-coupled from each other). The temperature controller 108 may be operatively coupled to the reagent cartridge 102 and the manifold assembly 118 by intervening components of the system 100, but the temperature controller 108 may not directly touch the manifold assembly 118. The temperature controller 108 may alternatively be in direct contact with or otherwise placed adjacent to the reagent reservoir 102, the manifold assembly 118, and/or the fluidic lines 120 and/or 122. The temperature controller 108 and/or its components 131 and/or 132 may, thus, be considered contact components (e.g., a contact heater, etc.) that allow heat and/or cold radiated and/or emitted from the respective heater 132 and/or cooler 136 to travel toward the fluidic line 120 and/or 122. The heater 132 may be in a relatively fixed position relative to the reagent cartridge 102 or the heater 132 may be movable relative to the reagent cartridge 102. The temperature controller 108 may include an actuator 145 when the heater 132 is movable. The actuator 145 may include a spring-biased plate, a linear actuator, etc. The actuator 145 may be omitted in other implementations. While the temperature sensor 131 is shown being part of the system 100, in other implementations, the reagent cartridge 102 may include the temperature sensor 131 and the system 100 may include the heater 132.

The temperature controller 108 may generally be used to increase and/or decrease the temperature of the fluidic lines 120, 122 and the reagent flowing therethrough and allow the temperature of the reagent to be within a threshold of a reference temperature prior to the reagent entering the flow cell assembly 127. The temperature sensor 131 is positioned to determine a temperature associated with at least one of the common fluidic line 120 or one or more of the reagent fluidic lines 122 to do so. The controller 106 is configured to compare the determined temperature value to a reference temperature value and cause the temperature controller 108 to change a temperature of at least one of the common fluidic line 120 or one or more of the reagent fluidic lines 122 when the determined temperature value is outside of a threshold of the reference temperature value.

The controller 106 may also include a proportional-integral-derivative (PID) temperature controller or a three-term controller that is used to determine an amount of power to provide to the temperature controller 108 to enable the determined and reference temperatures to be within a threshold of one another. The controller 106 includes a feedback loop that works in combination with the temperature controller 108 in some implementations to keep the temperature of the corresponding fluidic line 120 and/or 122 within a threshold of the reference temperature. The reference temperature may be approximately 60° C. or between about 45° C. and about 75° C. The reference temperature may be different however depending on the reagent, the analysis being performed, etc. The temperature sensor 131 may include a non-contact temperature sensor, a thermocouple, an infrared (IR) sensor, a thermistor, a thermostat, a resistance temperature detector (RTD), a Bi-metallic thermostat, an electro-mechanical temperature sensor, etc.

To change the temperature of the fluidic line 120 and/or 122, the heater 132 is positioned to heat at least one of the common fluidic line 120 or one or more of the reagent fluidic lines 122 and, similarly, the cooler 136 is positioned to cool at least one of the common fluidic line 120 or one or more of the reagent fluidic lines 122. The controller 106 accesses the temperature value determined by the temperature sensor 131 in operation and controls the heater 132 and/or the cooler 136 accordingly. The temperature controller 108 includes a relay 137 that is used to control the powering of the heater 132 and/or the cooler 136 in some implementations. The heater 132 may be a resistive heating element and/or a non-contact heater. Examples of non-contact heaters include an infrared heater, a LED heater, etc. The temperature controller 108 may include a lens or orifice 138 that directs a beam emitted by the heater 132 toward at least one of the common fluidic line 120 or one or more of the reagent fluidic lines 122 in some implementations such as when the heater 132 is a LED heater. The orifice 138 may allow heat emitted by the heater 132 to be directed onto the fluidic line 120 and/or 122 and block heat from being directed toward other areas of the reagent cartridge 102, for example.

Referring now to the cooler 136, the cooler 136 may be configured to flow air onto the fluidic line 120 and/or 122 and may include a nozzle 140, a valve 142, and a compressed air source 144 that is fluidically coupled to the nozzle 140 by the valve 142. The controller 106 may cause the valve 142 to actuate in operation and allow the air to flow from the compressed air source 144, out of the nozzle 140, and toward the fluidic line 120 and/or 122. The cooler 136 may additionally or alternatively include a fan.

While the temperature controller 108 is shown including the heater 132, the temperature sensor 131, and the cooler 136, one or more of the components 132, 131, and/or 136 may be omitted in other implementations. The temperature controller 108 may include various combinations of the components 132, 131, 136 such as including, for example: 1) the heater 132; 2) the heater 132 and the temperature sensor 131; 3) the heater 132 and the cooler 136; 4) the temperature sensor 131 and the cooler 136; and/or 5) the cooler 136, for example. The temperature sensor 131 may be carried by the reagent cartridge 102, as a further alternative.

Referring back to the reagent cartridge 102, the reagent cartridge 102 includes a pump 146 positioned between the flow cell assembly 127 and the waste reservoir 111. The pump 146 may be implemented by a syringe pump, a peristaltic pump, a diaphragm pump, etc. While the pump 146 is shown positioned between the flow cell assembly 127 and the waste reservoir 111, the pump 146 may be positioned upstream of the flow cell assembly 127 or omitted entirely in other implementations. The system 100 may alternatively include the pump 146.

The flow cell assembly 127 is carried by the reagent cartridge 102 in the implementation shown and is received within a flow cell receptacle 147. The flow cell assembly 127 can alternatively be integrated into the reagent cartridge 102. The flow cell receptacle 147 may not be included or, at least, the flow cell assembly 127 may not be removably receivable within the reagent cartridge 102 in such implementations. The flow cell assembly 127 may be separate from the reagent cartridge 102 as a further alternative.

Referring now to the drive assembly 104, the drive assembly 104 includes a pump drive assembly 148 and a valve drive assembly 150 in the implementation shown. The pump drive assembly 148 interfaces with the pump 146 to pump fluid through the reagent cartridge 102 and the valve drive assembly 150 interfaces with the valve 126 to control the position of the valve 126.

Referring to the controller 106, in the implementation shown, the controller 106 includes a user interface 152, a communication interface 154, one or more processors 156, and a memory 158 storing instructions executable by the one or more processors 156 to perform various functions including the disclosed implementation. The user interface 152, the communication interface 154, and the memory 158 are electrically and/or communicatively coupled to the one or more processors 156.

In an implementation, the user interface 152 is adapted to receive input from a user and to provide information to the user associated with the operation of the system 100 and/or an analysis taking place. The user interface 152 may include a touch screen, a display, a key board, a speaker(s), a mouse, a track ball, and/or a voice recognition system. The touch screen and/or the display may display a graphical user interface (GUI).

In an implementation, the communication interface 154 is adapted to enable communication between the system 100 and a remote system(s) (e.g., computers) via a network(s). The network(s) may include the Internet, an intranet, a local-area network (LAN), a wide-area network (WAN), a coaxial-cable network, a wireless network, a wired network, a satellite network, a digital subscriber line (DSL) network, a cellular network, a Bluetooth connection, a near field communication (NFC) connection, etc. Some of the communications provided to the remote system may be associated with analysis results, imaging data, etc. generated or otherwise obtained by the system 100. Some of the communications provided to the system 100 may be associated with a fluidics analysis operation, patient records, and/or a protocol(s) to be executed by the system 100.

The one or more processors 156 and/or the system 100 may include one or more of a processor-based system(s) or a microprocessor-based system(s). In some implementations, the one or more processors 156 and/or the system 100 includes one or more of a programmable processor, a programmable controller, a microprocessor, a microcontroller, a graphics processing unit (GPU), a digital signal processor (DSP), a reduced-instruction set computer (RISC), an application specific integrated circuit (ASIC), a field programmable gate array (FPGA), a field programmable logic device (FPLD), a logic circuit, and/or another logic-based device executing various functions including the ones described herein.

The memory 158 can include one or more of a semiconductor memory, a magnetically readable memory, an optical memory, a hard disk drive (HDD), an optical storage drive, a solid-state storage device, a solid-state drive (SSD), a flash memory, a read-only memory (ROM), erasable programmable read-only memory (EPROM), electrically erasable programmable read-only memory (EEPROM), a random-access memory (RAM), a non-volatile RAM (NVRAM) memory, a compact disc (CD), a compact disc read-only memory (CD-ROM), a digital versatile disk (DVD), a Blu-ray disk, a redundant array of independent disks (RAID) system, a cache, and/or any other storage device or storage disk in which information is stored for any duration (e.g., permanently, temporarily, for extended periods of time, for buffering, for caching).

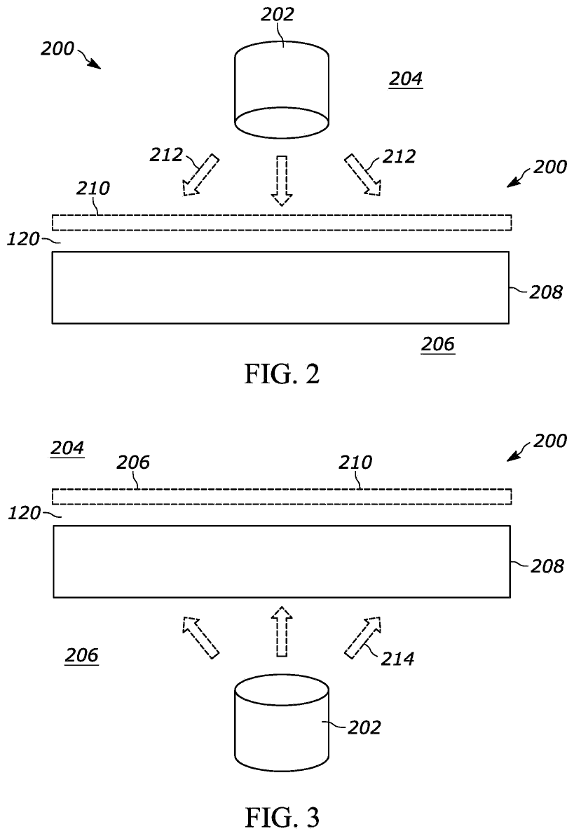

FIG. 2 is a detailed cross-sectional view of a portion of a manifold assembly 200 and a heater 202 that can be used to implement the manifold assembly 118 of the reagent cartridge 102 of FIG. 1 and the heater 132 of the system 100 of FIG. 1. While FIG. 2 includes the heater 132 positioned to heat the common fluidic line 120, the cooler 136 may additionally or alternatively be included and the heater 132 and/or the cooler 136 may be positioned to control the temperature of the reagent fluidic line 122.

The manifold assembly 200 has a first side 204 and a second side 206 in the implementation shown and includes a body 208 and a membrane 210 coupled to the body 208. The common fluidic line 120 is defined between the body 208 and the membrane 210. The heater 202 is implemented as an Infrared (IR) LED heater and is positioned on the first side 204 of the manifold assembly 200 to direct heat toward the membrane 210 in a direction generally indicated by arrows 212. While an IR LED heater is mentioned being used, a different type of heater may be used with the manifold assembly 200 of FIG. 2 and the heater 202 may be positioned in any location to heat the reagent and/or the common fluidic line 120.

FIG. 3 is another detailed cross-sectional view of the portion of the manifold assembly 200 and the heater 202 of FIG. 2 with the heater 202 positioned on the second side 206 of the manifold assembly 200 instead of being positioned on the first side 204 of the manifold assembly 200. The heater 202 is thus positioned to direct heat toward the body 208 of the manifold assembly 200 in a direction generally indicated by arrows 214 and generally opposite the direction indicated by arrows 212. While FIG. 3 includes the heater 132 positioned to heat the common fluidic line 120, the cooler 136 may additionally or alternatively be included and the heater 132 and/or the cooler 136 may be positioned to control the temperature of the reagent fluidic line 122.

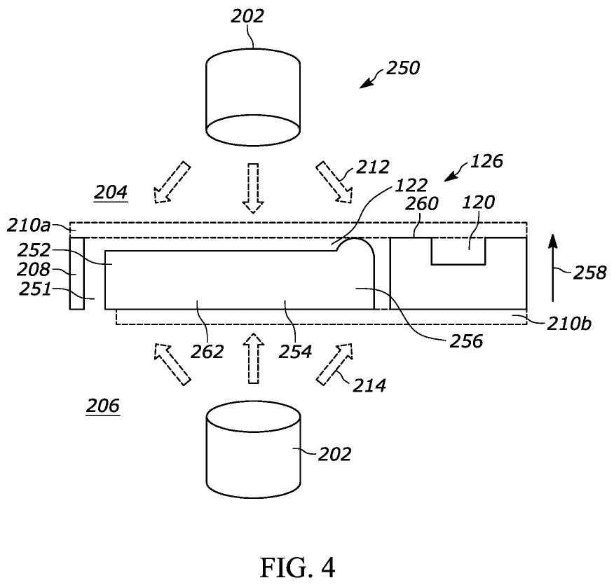

FIG. 4 is a detailed cross-sectional view of a portion of another manifold assembly 250 that can be used to implement the manifold assembly 118 of FIG. 1. The manifold assembly 250 illustrates a detailed view of an interface between the common fluidic line 120, the reagent fluidic line 122, and the valve 126 with the heaters 202 being positioned on both sides 204, 206 of the reagent fluidic line 122 of the manifold assembly 250. While the heaters 202 are positioned on both sides 204, 206 of the reagent fluidic line 122, the heaters 202 may additionally or alternatively be positioned on either side of the common fluidic line 120.

The manifold assembly 250 includes the body 208 defining an inlet 251 and the common fluidic line 120, as shown. The manifold assembly 250 also includes an actuator 252 captured between opposing membranes 210a, 210b that form a portion of the fluidic lines 120, 122. The actuator 252 is a cantilever 254 having a distal end 256 adapted to move in a direction generally indicated by arrow 258 to move the upper membrane 210a away from a valve seat 260 of the valve 126 and allow fluid to flow from the reagent fluidic line 122 into the common fluidic line 120. The cantilever 254 has a proximal end 262 opposite the distal end 256 that may be pivotably coupled to the body 116 of the manifold assembly 250.

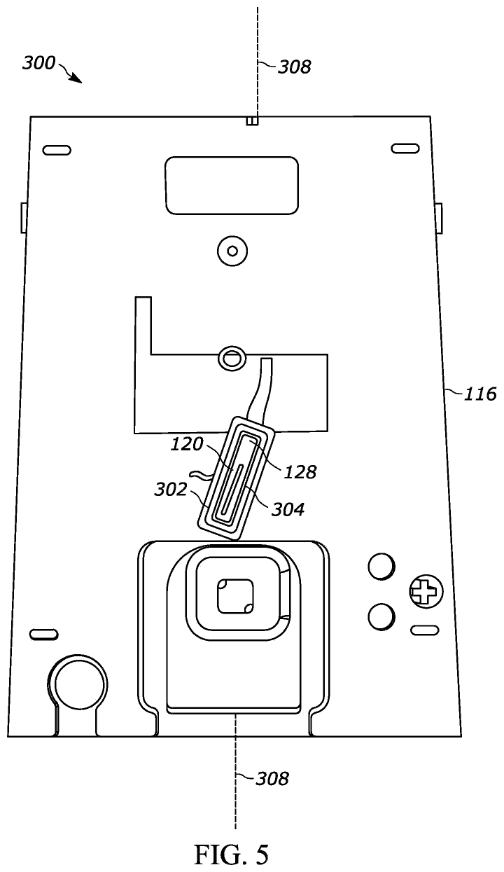

FIG. 5 is a top plan view of another reagent cartridge 300 that can be used to implement the reagent cartridge 102 of FIG. 1. The reagent cartridge 300 includes the window 128 in the implementation shown and the body 116 is formed as a shell that surrounds at least some components of the reagent cartridge 102. The window 128 is formed by a tapered surface 302 that flares outwardly and a central surface 304 that provides access into the body 208. The window 128 is positioned over a portion of the common fluidic line 120 and is rectangular and angled relative to a longitudinal axis 308 of the reagent cartridge 102. While the window 128 is shown having particular features and having a particular shape, size, and location, the tapered surface 302 forming the window 128 may be omitted and/or the window 128 may have any other shape and/or size. The window 128 may be positioned in a different location than shown. The window 128 may be positioned over one or more of the reagent fluidic lines 122 in addition to or instead of being positioned over the common fluidic line 120, for example.

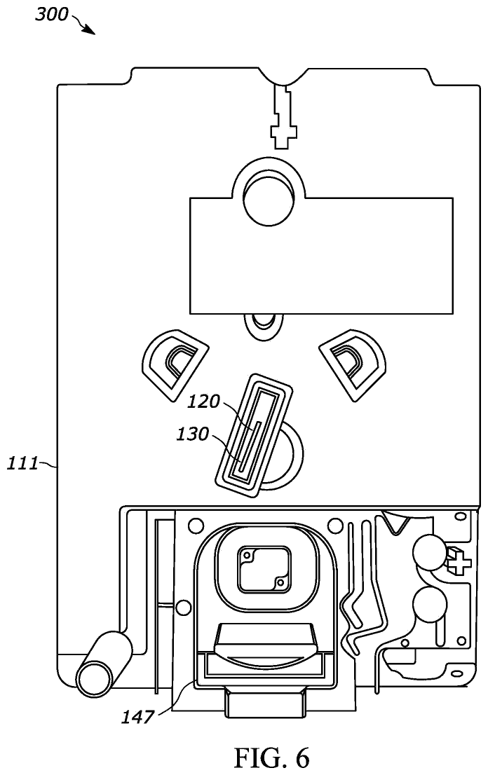

FIG. 6 is a top plan view of the reagent cartridge 300 of FIG. 5 that excludes the body 116 of the reagent cartridge 300 to more clearly illustrate the waste reservoir 111. The waste reservoir 111 defines the window 130 that is positioned over at least a portion of the common fluidic line 112 in the implementation shown and is alignable with the window 128 of the body 116 of the reagent cartridge 102.

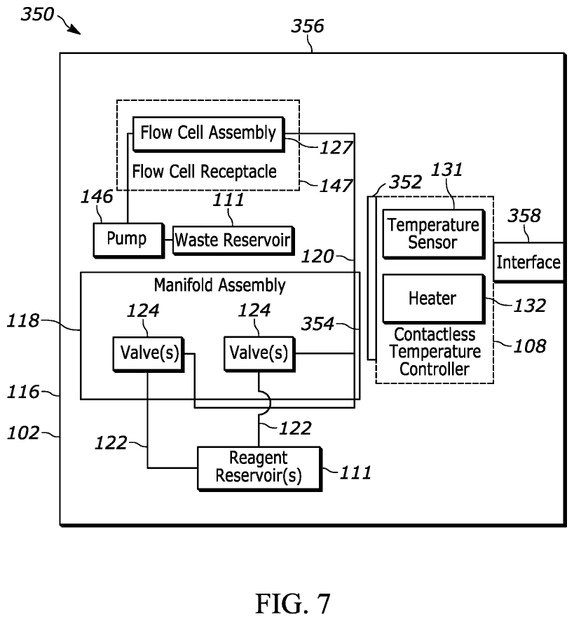

FIG. 7 is a schematic diagram of another reagent cartridge 350 that can be used with the system 100 of FIG. 1. The reagent cartridge 350 of FIG. 7 is similar to the reagent cartridge 102 of FIG. 1. The temperature controller 108 is carried by the reagent cartridge 102 instead of being part of the system 100 however and, as shown, is coupled to the reagent cartridge 350 using adhesive 352. The temperature controller 108 is thus not spaced from the reagent cartridge 350.

The temperature controller 108 is coupled to a surface 354 of the manifold assembly 118 in the implementation shown and the cooler 136 is omitted. The temperature controller 108 may be carried by or otherwise coupled to the reagent cartridge 350 in any way, however. The temperature controller 108 may be positioned within the body 116 of the reagent cartridge 350, the temperature controller 108 may be coupled to an external surface 356 of the reagent cartridge 350, etc., for example.

As with the temperature controller 108 of FIG. 1, the temperature controller 108 of FIG. 7 includes the temperature sensor 131 and the heater 132. The temperature sensor 131 may be a thermocouple and the heater 132 may be a flexible heater such as a polyimide film heater. When the heater 132 is implemented as a flexible heater, the heater 132 may be shaped to correspond to and/or overlay a portion the fluidic line 120, 122. The reagent cartridge 350 also includes an interface 358 that may couple with the system 100 to allow the system 100 to provide power to the temperature controller 108, for data and/or instructions to be exchanged between the reagent cartridge 350 and the system 100, and/or for the system 100 to control the temperature controller 108.

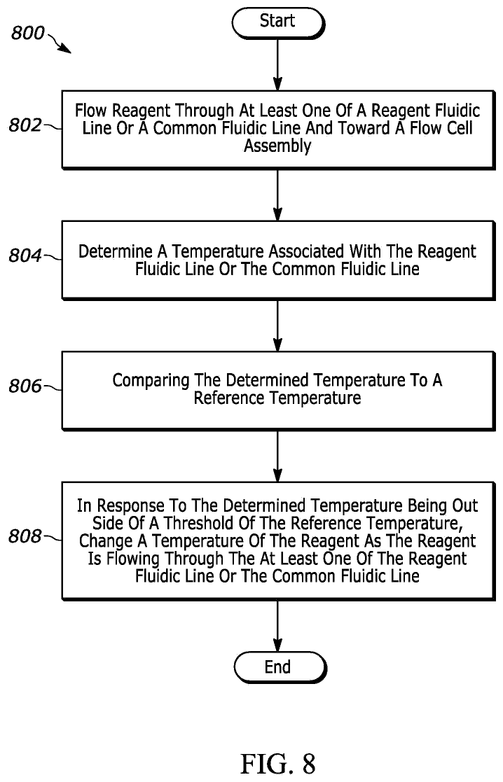

FIG. 8 illustrates a flowchart for a method of controlling a temperature of reagent flowing through the fluidic line 120 and/or 122 using the system 100 of FIG. 1 or any of the disclosed implementations. The order of execution of the blocks may be changed, and/or some of the blocks described may be changed, eliminated, combined, and/or subdivided into multiple blocks.

The process 800 of FIG. 8 begins with the reagent being flowed through at least one of the reagent fluidic line 122 or the common fluidic line 120 and toward the flow cell assembly 127 (Block 802). The temperature associated with the reagent fluidic line 122 or the common fluidic line 120 is determined (Block 804). The temperature is determined using the temperature sensor 131 that is part of the system 100 in some implementations or that is carried by the reagent cartridge 102, 300. The determined temperature is compared to a reference temperature (Block 806). The processor 156 of the controller 106 accesses the determined temperature value from the temperature sensor 131 in some implementations and accesses the reference temperature value from the memory 158 and compares the temperature values to determine if the determined temperature value is outside of a threshold of the reference temperature value. In response to the determined temperature being outside of a threshold of the reference temperature, a temperature of the reagent is changed as the reagent is flowing through at least one of the reagent fluidic line 122 or the common fluidic line 120 (Block 808).

Changing the temperature of the reagent includes heating at least one of the reagent fluidic line 122 or the common fluidic line 120 in some implementations. Heating the at least one of the reagent fluidic line 122 or the common fluidic line 120 includes heating the common fluidic line 120 and substantially not heating the reagent fluidic line 122 in some implementations. As set forth herein, the phrase “substantially not heating the reagent fluidic line” means that heat is not intentionally directed toward the reagent fluidic line 122. The heating the at least one of the reagent fluidic line 122 or the common fluidic line 120 alternatively includes heating the reagent fluidic line 122 and not heating the common fluidic line 120. Other heating arrangements may prove suitable, however. Heating at least one of the reagent fluidic line 122 or the common fluidic line 120 may include using at least one of a flexible heater, an infrared heater, or a LED heater. Additional or alternative types of heaters may be used, however.

Changing the temperature of at least one of the reagent fluidic line or the common fluidic line may include cooling at least one of the reagent fluidic line 122 or the common fluidic line 120. The cooling process may include flowing compressed air toward the at least one of the common fluidic line 120 or the reagent fluidic line 122. Cooling the reagent may be advantageous during some processes such as during imaging.

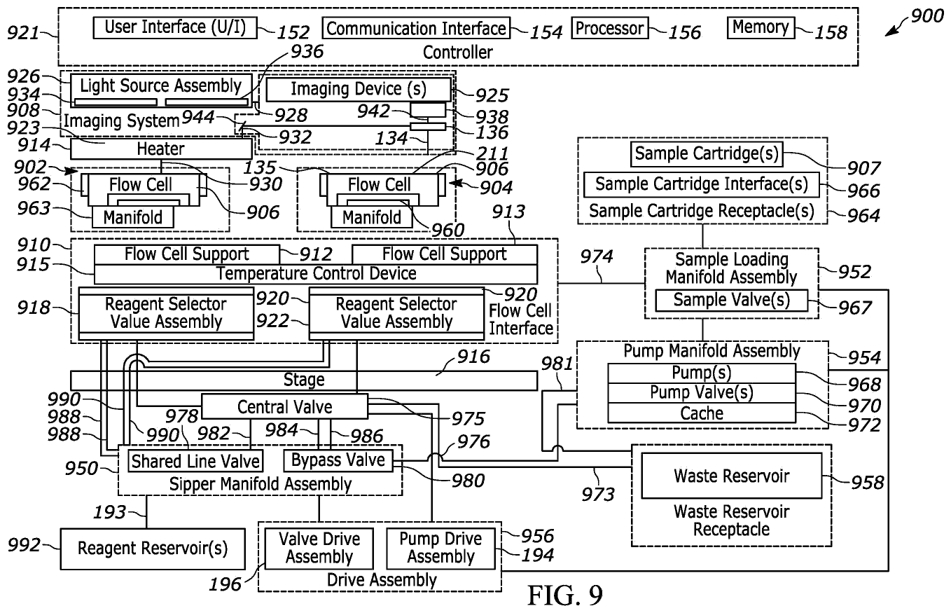

FIG. 9 illustrates a schematic diagram of an example implementation of a system 900 in accordance with teachings of the disclosure. The system 900 can be used to perform an analysis on one or more samples of interest. The sample may include one or more DNA clusters that have been linearized to form a single stranded DNA (sstDNA). The system 900 is adapted to receive a pair of flow cell assemblies 902, 904 including corresponding flow cells 906 in the implementation shown. The system 900 includes, in part, one or more sample cartridges 907, an imaging system 908, and a flow cell interface 910 having flow cell supports 912, 913 that support corresponding flow cell assemblies 902, 904. The flow cell interface 910 may be associated with and/or referred to as a flow cell deck and the flow cell supports 912, 913 may be associated with and/or referred to as a flow cell chuck.

The system 900 also includes a non-contact heater 914, a temperature control device 915, a stage assembly 916, a pair of reagent selector valve assemblies 918, 920, and a controller 106. The non-contact heater 914 may be a LED heater 923 and the temperature control device 915 may be a thermoelectric cooler. The reagent selector valve assemblies 918, 920 each include a reagent selector valve 921 and a valve drive assembly 922. The reagent selector valve assemblies 918, 920 may be referred to as mini-valve assemblies. The controller 106 is electrically and/or communicatively coupled to the imaging system 908, the reagent selector valve assemblies 918, 920, the non-contact heater 914, the temperature control device 915, and the stage assembly 916, and is adapted to cause the imaging system 908, the reagent selector valve assemblies 918, 920, the non-contact heater 914, the temperature control device 915, and the stage assembly 916 to perform various functions as disclosed herein.

The controller 106 causes the non-contact heater 914 to change a temperature of the flow cell(s) 906 in operation. Heating the flow cell 906 and, thus, the reagent flowing into and/or within the flow cell 906 allows a temperature of the flow cell 906 to not decrease as much when the reagent enters the flow cell 906 or at least decreases the possible duration for which a temperature of the flow cell 906 falls below a threshold temperature as compared to when the reagent entering the flow cell 906 is not heated or is below the temperature of the flow cell 906.

The non-contact heater 914 is carried by the imaging device 908 in the implementation shown. The position of the non-contact heater 914 allows the imaging system 908 to image one of the flow cells 906 while the non-contact heater 914 heats the other one of the flow cells 906 before, as, and/or after reagents are flowed into the other of the flow cells 906. The non-contact heater 914 may emit a beam 930 directed toward the flow cell 906 that heats the flow cell 906. The non-contact heater 914 may emit wavelengths that are not absorbed by dyes on the fully functional nucleotides to avoid DNA damage and/or dye bleaching.

The non-contact heater 914 may alternatively be part of the imaging system 908. The imaging system 908 includes an imaging device 925, an optical assembly 926, and a light source assembly 927 to emit a beam 928 that is received by the optical assembly 926 in the implementation shown. The non-contact heater 914 may emit a beam 932 that is received by the optical assembly 926 in such implementations. The temperature control device 915 may be positioned underneath the flow cell support 912, 913 and controls a temperature of the flow cell support 912, 913 using the temperature control device 915. The temperature control device 915, thus, heats/cools the flow cell support 912, 913 and the flow cells 906 on the flow cell support 912, 913.

The light source assembly 927 also includes a beam source 934 and a collimator 936 and the optical assembly 926 includes a beam shaping group 938 and a focusing objective 940. The beam source 934 provides input radiation in operation and the collimator 936 substantially collimates the input radiation from the beam source 934 to form the beam 928. The beam 928 may be a substantially collimated beam. The beam shaping group 938 includes one or more optical elements and is positioned to receive the beam 928 from the collimator 936. The beam shaping group 938 form the beam 928 into a shaped propagation beam 942. The focusing objective 940 is provided between the beam shaping group 938 and the sample flow cell 906 to focus the shaped propagation beam 942 onto the flow cell 906.

The non-contact heater 914 may be positioned adjacent the beam source 934 and, thus, the non-contact heater 914 may emit the beam 932 and the beam 932 may be received by the collimator 936, the beam shaping group 938, and the focusing objective 940 which directs the beam 932 onto the flow cell 906. The collimator 936, the beam shaping group 938, and the focusing objective 940 may however absorb heat as the beam 932 from the non-contact heater 914 passes through the corresponding optical elements. Heating an optical element may cause a gradient in focusing power across the optical elements and cause uneven thermal expansions and refractive index changes that result in astigmatism in the line-shaped beam, image quality degradations in linescan images, and/or any other degradations.

The optical assembly 926 may also include a directional optical element 944 that redirects the beam 932 of the non-contact heater 914 to the focusing objective 940. The beam 932 from the non-contact heater 914 does not pass through the collimator 936 and the beam shaping group 938 and, thus, avoids heating the optical elements of the collimator 936 and the beam shaping group 938 in such implementations.

The system 900 of FIG. 9 also includes a sipper manifold assembly 950, a sample loading manifold assembly 952, a pump manifold assembly 954, a drive assembly 956, and a waste reservoir 958 in the implementation shown. The controller 106 is electrically and/or communicatively coupled to the sipper manifold assembly 950, the sample loading manifold assembly 952, the pump manifold assembly 954, and the drive assembly 956, and is adapted to cause the sipper manifold assembly 950, the sample loading manifold assembly 952, the pump manifold assembly 954, and the drive assembly 956 to perform various functions as disclosed herein.

Each of the flow cells 906 includes a plurality of channels 960 in the implementation shown. Each of the channels 960 has a first channel opening positioned at a first end of the flow cell 906 and a second channel opening positioned at a second end of the flow cell 906. Depending on the direction of flow through the channels 960, either of the channel openings may act as an inlet or an outlet. While the flow cells 906 are shown including two channels 960 in FIG. 9, any number of channels 960 may be included (e.g., 1, 2, 6, 8).

Each of the flow cell assemblies 902, 904 also includes a flow cell frame 962 and a flow cell manifold 963 coupled to the first end of the corresponding flow cell 906. As shown, the flow cell 906, the flow cell manifold 963, and/or any associated gaskets used to establish a fluidic connection between the flow cell 906 and the system 900 are coupled or otherwise carried by the flow cell frame 962. While the flow cell frame 962 is shown included with the flow cell assemblies 902, 904 of FIG. 9, the flow cell frame 962 may be omitted. The flow cell 906 and the associated flow cell manifold 963 and/or gaskets as such may be used with the system 900 without the flow cell frame 962.

It is noted that while some components of the system 900 of FIG. 9 are shown once and as being coupled to both of the flow cells 906, these components may be duplicated such that each flow cell 906 has its own corresponding components in some implementations and the system 900 may include more than two flow supports 912, 913 and corresponding components. Each flow cell 906 may be associated with a separate sample cartridge 907, sample loading manifold assembly 952, pump manifold assembly 954, etc., for example. The system 900 may include a single flow cell 906 and corresponding components in other implementations.

The system 900 includes a sample cartridge receptacle 964 that receives the sample cartridge 907 that carries one or more samples of interest (e.g., an analyte). The system 900 also includes a sample cartridge interface 966 that establishes a fluidic connection with the sample cartridge 907.

The sample loading manifold assembly 952 includes one or more sample valves 967, and the pump manifold assembly 954 includes one or more pumps 968, one or more pump valves 970, and a cache 972. One or more of the valves 967, 970 may be implemented by a rotary valve, a pinch valve, a flat valve, a solenoid valve, a check valve, a piezo valve, and/or a three-way valve. Different types of fluid control devices may be used, however. One or more of the pumps 968 may be implemented by a syringe pump, a peristaltic pump, and/or a diaphragm pump. Other types of fluid transfer devices may be used, however. The cache 972 may be a serpentine cache and may temporarily store one or more reaction components during bypass manipulations of the system 900 of FIG. 9, for example. While the cache 972 is shown being included in the pump manifold assembly 954, the cache 972 may be located in a different location, in another implementation. The cache 972 may be included in the sipper manifold assembly 950 or in another manifold downstream of a bypass fluidic line 973, for example.

The sample loading manifold assembly 952 and the pump manifold assembly 954 flow one or more samples of interest from the sample cartridge 907 through a fluidic line 974 toward the flow cell assemblies 902, 904, in the implementation shown. The sample loading manifold assembly 952 can individually load/address each channel 960 of the flow cells 906 with a sample of interest in some implementations. The process of loading the channels 960 of the flow cells 906 with a sample of interest may occur automatically using the system 900 of FIG. 9.

The sample cartridge 907 and the sample loading manifold assembly 952 are positioned downstream of the flow cell assemblies 902, 904 as shown in the system 900 of FIG. 9. The sample loading manifold assembly 952 may, thus, load a sample of interest into the flow cell(s) 906 from the rear of the flow cell(s) 906. Loading a sample of interest from the rear of the flow cell(s) 906 may be referred to as “back loading.” Back loading the sample of interest into the flow cell(s) 906 may reduce contamination. The sample loading manifold assembly 952 is coupled between the flow cell assemblies 902, 904 and the pump manifold assembly 954, in some implementations.

To draw a sample of interest from the sample cartridge 907 and toward the pump manifold assembly 954, the sample valves 967, the pump valves 970, and/or the pumps 968 may be selectively actuated to urge the sample of interest toward the pump manifold assembly 954. The sample cartridge 907 may include a plurality of sample reservoirs that are selectively fluidically accessible via the corresponding sample valve 967. Each sample reservoir can thus be selectively isolated from other sample reservoirs using the corresponding sample valves 967.

The sample valves 967, the pump valves 970, and/or the pumps 968 can be selectively actuated to urge the sample of interest toward the flow cell assembly 902 and into the respective channels 960 of the corresponding flow cell 906 to individually flow the sample of interest toward a corresponding channel of one of the flow cells 906 and away from the pump manifold assembly 954. Each channel 960 of the flow cell(s) 906 receives the sample of interest in some implementations. One or more of the channels 960 of the flow cell(s) 906 selectively receives the sample of interest and others of the channels 960 of the flow cell(s) 906 do not receive the sample of interest in other implementations. The channels 960 of the flow cell(s) 906 that may not receive the sample of interest may receive a wash buffer instead, for example.

The drive assembly 956 interfaces with the sipper manifold assembly 950 and the pump manifold assembly 954 to flow one or more reagents that interact with the sample within the corresponding flow cell(s) 906. A reversible terminator may be attached to the reagent to allow a single nucleotide to be incorporated onto a growing DNA strand. One or more of the nucleotides has a unique fluorescent label that emits a color when excited, in some such implementations. The color (or absence thereof) is used to detect the corresponding nucleotide. The imaging system 908 may excite one or more of the identifiable labels (e.g., a fluorescent label) and thereafter obtains image data using the imaging device 925 for the identifiable labels, in the implementation shown. The labels may be excited by incident light and/or a laser and the image data may include one or more colors emitted by the respective labels in response to the excitation. The image data (e.g., detection data) may be analyzed by the system 900. The imaging system 908 may be a fluorescence spectrophotometer including an objective lens and/or the imaging device 925. The imaging device 925 may include a charge coupled device (CCD) and/or a complementary metal oxide semiconductor (CMOS) device. However, other types of imaging systems 908 and/or optical instruments may be used. The imaging system 908 may be or be associated with a scanning electron microscope, a transmission electron microscope, an imaging flow cytometer, high-resolution optical microscopy, confocal microscopy, epifluorescence microscopy, two photon microscopy, differential interference contrast microscopy, etc., for example.

After the image data is obtained, the drive assembly 956 interfaces with the sipper manifold assembly 950 and the pump manifold assembly 954 to flow another reaction component (e.g., a reagent) through the flow cell(s) 906 that is thereafter received by the waste reservoir 958 via a primary waste fluidic line 981 and/or otherwise exhausted by the system 900. Some reaction components perform a flushing operation that chemically cleaves the fluorescent label and the reversible terminator from the sstDNA. The sstDNA is then ready for another cycle.

The primary waste fluidic line 981 is coupled between the pump manifold assembly 954 and the waste reservoir 958. The pumps 968 and/or the pump valves 970 of the pump manifold assembly 954 may selectively flow the reaction components from the flow cell assembly 902, 904, through the fluidic line 974 and the sample loading manifold assembly 952 to the primary waste fluidic line 981.

The flow cell assemblies 902, 904 are coupled to a central valve 975 via the flow cell interface 910. An auxiliary waste fluidic line 976 is coupled to the central valve 975 and to the waste reservoir 958. The auxiliary waste fluidic line 976 receives excess fluid of a sample of interest from the flow cell assembly 902, 904, via the central valve 975, and flows the excess fluid of the sample of interest to the waste reservoir 958 in some implementations when back loading the sample of interest into the flow cell(s) 906, as described herein. That is, the sample of interest may be loaded from the rear of the flow cell(s) 906 and any excess fluid for the sample of interest may exit from the front of the flow cell(s) 906. Different samples can be separately loaded to corresponding channels 960 of the corresponding flow cell(s) 906 by back loading samples of interest into the flow cell(s) 906 and the single flow cell manifold 963 can couple the front of the flow cell(s) 906 to the central valve 975 to direct excess fluid of each sample of interest to the auxiliary waste fluidic line 976. Once the samples of interest are loaded into the flow cell(s) 906, the flow cell manifold 963 can be used to deliver common reagents from the front of the flow cell(s) 906 (e.g., upstream) for each channel 960 of the flow cell(s) 906 that exit from the rear of the flow cell(s) 906 (e.g., downstream). Put another way, the sample of interest and the reagents may flow in opposite directions through the channels 960 of the flow cell(s) 906.

The sipper manifold assembly 950 includes a shared line valve 978 and a bypass valve 980, in the implementation shown. The shared line valve 978 may be referred to as a reagent selector valve. The reagent selector valves 921 of the reagent selector valve assemblies 918, 920, the central valve 975 and/or the valves 978, 980 of the sipper manifold assembly 950 may be selectively actuated to control the flow of fluid through fluidic lines 982, 984, 986, 988, 990. One or more of the valves 921, 970, 975, 978, 980 may be implemented by a rotary valve, a pinch valve, a flat valve, a solenoid valve, a check valve, a piezo valve, etc. Other fluid control devices may prove suitable.

The sipper manifold assembly 950 may be coupled to a corresponding number of reagents reservoirs 992 via reagent sippers 993. The reagent reservoirs 992 may contain fluid (e.g., reagent and/or another reaction component). The sipper manifold assembly 950 may include a plurality of ports. Each port of the sipper manifold assembly 950 may receive one of the reagent sippers 993. The reagent sippers 993 may be referred to as fluidic lines.

The shared line valve 978 of the sipper manifold assembly 950 is coupled to the central valve 975 via the shared reagent fluidic line 982. Different reagents may flow through the shared reagent fluidic line 982 at different times. When performing a flushing operation before changing between one reagent and another, the pump manifold assembly 954 may draw wash buffer through the shared reagent fluidic line 982, the central valve 975, and the corresponding flow cell assembly 902, 904. The shared reagent fluidic line 982 may, thus, be involved in the flushing operation. While one shared reagent fluidic line 982 is shown, any number of shared fluidic lines may be included in the system 900.

The bypass valve 980 of the sipper manifold assembly 950 is coupled to the central valve 975 via the reagent fluidic lines 984, 986. The central valve 975 may have one or more ports that correspond to the reagent fluidic lines 984, 986.

The dedicated fluidic lines 988, 990 are coupled between the sipper manifold assembly 950 and the reagent selector valve assemblies 918, 920. Each of the dedicated reagent fluidic lines 988, 990 may be associated with a single reagent. The fluids that may flow through the dedicated reagent fluidic lines 988, 990 may be used during sequencing operations and may include a cleave reagent, an incorporation reagent, a scan reagent, a cleave wash, and/or a wash buffer. The dedicated reagent fluidic lines 988, 990 themselves may not be flushed when performing a flushing operation before changing between one reagent and another because only a single reagent may flow through each of the dedicated reagent fluidic lines 988, 990. The approach of including dedicated reagent fluidic lines 988, 990 may be advantageous when the system 900 uses reagents that may have adverse reactions with other reagents. Reducing a number of fluidic lines or length of the fluidic lines that are flushed when changing between different reagents reduces reagent consumption and flush volume and may moreover decrease cycle times of the system 900. While four dedicated reagent fluidic lines 988, 990 are shown, any number of dedicated fluidic lines may be included in the system 900.

The bypass valve 980 is also coupled to the cache 972 of the pump manifold assembly 954 via the bypass fluidic line 973. One or more reagent priming operations, hydration operations, mixing operations, and/or transfer operations may be performed using the bypass fluidic line 973. The priming operations, the hydration operations, the mixing operations, and/or the transfer operations may be performed independent of the flow cell assembly 902, 904. The operations using the bypass fluidic line 973 may, thus, occur during, incubation of one or more samples of interest within the flow cell assembly 902, 904, for example. That is, the shared line valve 978 can be utilized independently of the bypass valve 980 such that the bypass valve 980 can utilize the bypass fluidic line 973 and/or the cache 972 to perform one or more operations while the shared line valve 978 and/or the central valve 975 simultaneously, substantially simultaneously, or offset synchronously perform other operations. The system 900 can, thus, perform multiple operations at once, thereby reducing run time.

The drive assembly 956 includes a pump drive assembly 194 and a valve drive assembly 196, in the implementation shown. The pump drive assembly 194 may be adapted to interface with the one or more pumps 968 to pump fluid through the flow cell 906 and/or to load one or more samples of interest into the flow cell 906. The valve drive assembly 196 may be adapted to interface with one or more of the valves 967, 970, 975, 978, 980 to control the position of the corresponding valves 967, 970, 975, 978, 980.

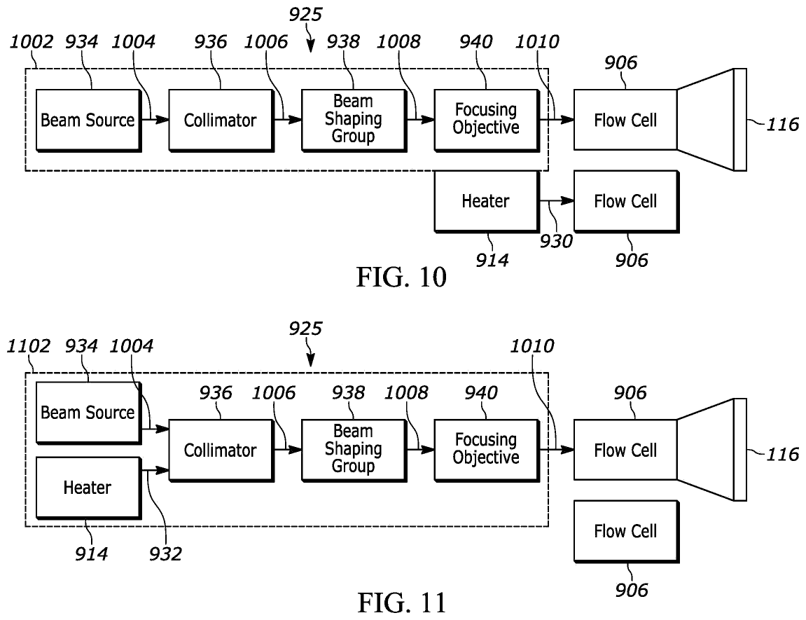

FIG. 10 illustrates a schematic representation of an example imaging system 1002 and the non-contact heater 914 that can be used to implement the imaging system 908 and the non-contact heater 914 of FIG. 9. The non-contact heater 914 is shown being carried by the imaging system 1002. The non-contact heater 914 may alternatively be coupled to a portion such as a frame or another component of the system 900.

The imaging system 1002 includes the beam source 934 that generates an input beam 1004. The collimator 936 receives the input beam 1004 and generates a substantially collimated propagation beam 1006 from the input beam 1004. The beam shaping group includes one or more optical elements and is positioned to receive the collimated beam 1006 from the collimator 102. The beam shaping group 110 formats the collimated beam 1006 into a shaped propagation beam 1008. The focusing objective 940 is positioned between the beam shaping group 938 and the flow cell 906 and focuses the shaped propagation beam 1008 onto the flow cell 906. The focusing objective 940 transforms the shaped propagation beam 1008 into a sampling beam 1010 at a focal plane of the focusing objective stage and having a substantially rectangular beam profile such as profile 1012, for example.

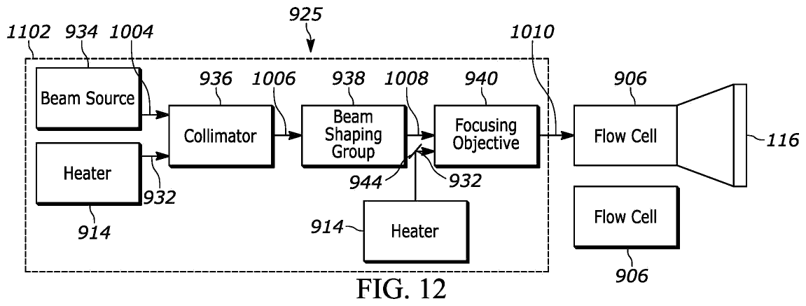

FIG. 11 illustrates a schematic representation of an example imaging system 1102 and the non-contact heater 914 that can be used to implement the imaging system 908 and the non-contact heater 914 of FIG. 9. The imaging system 1102 of FIG. 12 is similar to the imaging system 1002 of FIG. 10. The imaging system 1102 of FIG. 11 includes the non-contact heater 914 positioned adjacent the beam source 934, however. The non-contact heater 914 thus emits the beam 932 that is received by the collimator 936, the beam shaping group 938, and the focusing objective 940 which directs the beam 932 onto the flow cell 906.

FIG. 12 illustrates a schematic representation of an example optical assembly 1202 and the non-contact heater 914 that can be used to implement the optical assembly 926 and the non-contact heater 914 of FIG. 9. The optical assembly 1202 of FIG. 11 is similar to the imaging system 1002 of FIG. 10 and the optical imaging system 1102 of FIG. 12. The imaging system 1102 of FIG. 11 includes the non-contact heater 914 and the directional optical element 944 that redirects the beam 932 of the non-contact heater 914 to the focusing objective 940. The beam 932 from the non-contact heater 914 does not pass through the collimator 936 and the beam shaping group 938 and, thus, avoids heating the optical elements of the collimator 936 and the beam shaping group 938 in such implementations.

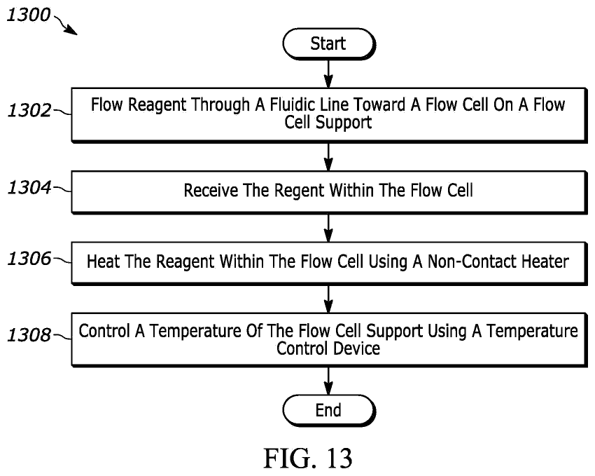

FIG. 13 illustrates a flowchart for a method of controlling a temperature of reagent and/or of the flow cell 106 using the system 900 of FIG. 9 or any of the disclosed implementations. The order of execution of the blocks may be changed, and/or some of the blocks described may be changed, eliminated, combined, and/or subdivided into multiple blocks.

The process 1300 of FIG. 13 begins with the reagent being flowed through a fluidic line 982, 984, 986, 988, 990 toward the flow cell 106 on the flow cell support 912, 913 (Bock 1302). The regent is received within the flow cell 906 (Block 1304). The reagent is heated within the flow cell 906 using the non-contact heater 914 (Block 1306). The non-contact heater 914 can be an LED heater 923. The reagent may be heated by illuminating the non-contact heater 914 for short periods of time such as for twenty seconds, for example. Other time periods may prove suitable.

The reagent within the flow cell 906 may be heated using the non-contact heater 914 by the non-contact heater 914 emitting a beam 930 and directing the beam 930 to the flow cell 906 in some implementations. The reagent within the flow cell 906 may alternatively be heated using the non-contact heater 914 by the non-contact heater 914 emitting the beam 932, redirecting the beam 932 to the optical assembly 926, and projecting the redirected beam 932 onto the flow cell 106. The directional optical element 944 may be used to redirect the beam 932 to the optical assembly 926 in some implementations. The reagent within the flow cell 906 may alternatively be heated using the non-contact heater 914 by the non-contact heater 914 emitting the beam 932, receiving the beam 932 at the optical assembly 926, and projecting the beam 932 onto the flow cell 906. A temperature of the flow cell support 912, 913 is controlled using the temperature control device 915 (Block 1308). The temperature control device 915 may be a thermoelectric cooler.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

As used herein, an element or step recited in the singular and proceeded with the word “a” or “an” should be understood as not excluding plural of said elements or steps, unless such exclusion is explicitly stated. Furthermore, references to “one implementation” are not intended to be interpreted as excluding the existence of additional implementations that also incorporate the recited features. Moreover, unless explicitly stated to the contrary, implementations “comprising,” “including,” or “having” an element or a plurality of elements having a particular property may include additional elements whether or not they have that property. Moreover, the terms “comprising,” including, “having,” or the like are interchangeably used herein.

The terms “substantially,” “approximately,” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art, without departing from the scope of the subject technology. For instance, different numbers of a given module or unit may be employed, a different type or types of a given module or unit may be employed, a given module or unit may be added, or a given module or unit may be omitted.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

1. An apparatus, comprising:
a system, including:
a reagent cartridge receptacle;
a non-contact temperature controller; and
a processor operatively coupled to the temperature controller;
a reagent cartridge receivable within the reagent cartridge receptacle, the reagent cartridge, comprising:
a flow cell assembly;
a plurality of reagent reservoirs; and
a manifold assembly, comprising:
a common fluidic line; and
a plurality of reagent fluidic lines, each of the plurality of reagent fluidic lines being adapted to be fluidically coupled to a corresponding reagent reservoir and selectively couplable to the common fluidic line,
wherein the processor is to cause the temperature controller to change a temperature of at least one of the common fluidic line or one or more of the reagent fluidic lines.

2. The apparatus of claim 1, wherein the reagent cartridge comprises a body having a window to enable the temperature controller to change a temperature of at least one of the common fluidic line or one or more of the reagent fluidic lines.

3. The apparatus of claim 2, wherein the reagent cartridge further comprises a waste reservoir having a second window that is aligned with the window of the body.

4. The apparatus of claim 1, wherein the temperature controller is spaced from the manifold assembly.

5. The apparatus of claim 1, wherein the temperature controller comprises a temperature sensor positioned to determine a temperature associated with at least one of the common fluidic line or one or more of the reagent fluidic lines and, the processor is configured to compare the determined temperature to a reference temperature, and wherein in response to the determined temperature being outside of a threshold of the reference temperature, the processor causes the temperature controller to change a temperature of at least one of the common fluidic line or one or more of the reagent fluidic lines.

6. The apparatus of claim 1, wherein the temperature controller comprises a heater and a temperature sensor, the heater being positioned to heat at least one of the common fluidic line or one or more of the reagent fluidic lines and the temperature sensor being positioned to determine a temperature associated with at least one of the common fluidic line or one or more of the reagent fluidic lines, and wherein the processor is adapted to control the heater based on the temperature determined by the temperature sensor.

7. The apparatus of claim 6, wherein the heater comprises at least one of a non-contact heater an infrared heater, and/or a LED heater.

8-9. (canceled)

10. The apparatus of claim 7, further comprising an orifice positioned to direct a beam emitted by the LED heater toward the at least one of the common fluidic line or one or more of the reagent fluidic lines.

11. The apparatus of claim 1, wherein the temperature controller further comprises a cooler, wherein the cooler comprises a nozzle, a valve, and an air source fluidically coupled to the nozzle by the valve.

12. (canceled)

13. The apparatus of claim 1, wherein the manifold assembly comprises a body and a membrane coupled to a surface of the body and the common fluidic line is defined between the membrane and the body, the body being on a first side of the common fluidic line and the membrane being on a second side of the common fluidic line.

14. The apparatus of claim 13, wherein the temperature controller is positioned on at least one of the first side or the second side of the common fluidic line to change a temperature of the common fluidic line.

15. The apparatus of claim 13, wherein the reagent fluidic lines of the manifold assembly are defined between the membrane and the body, wherein each of reagent fluidic lines comprises a membrane valve and a corresponding actuator disposed within the manifold assembly adapted to move the opposing membrane away from a valve seat of the corresponding membrane valve.

16. The apparatus of claim 15, wherein the temperature controller is positioned on at least one of the first side or the second side of the common fluidic line to change a temperature of the corresponding reagent fluidic line.

17. An apparatus, comprising:
a reagent cartridge comprising:
a plurality of reagent reservoirs;
a temperature controller; and
a manifold assembly, comprising:
a common fluidic line; and
a plurality of reagent fluidic lines, each of the plurality of reagent fluidic lines being adapted to be fluidically coupled to a corresponding reagent reservoir,
wherein the temperature controller is positioned to apply at least one of heat or cold to the common fluidic line.

18. The apparatus of claim 17, wherein the temperature controller is coupled to a surface of the reagent cartridge, the temperature controller comprising a heater and a temperature sensor, the heater being positioned to heat the common fluidic line and the temperature sensor is positioned to determine a temperature associated with the common fluidic line.

19-20. (canceled)

21. The apparatus of claim 18, wherein the heater comprises a flexible heater and the temperature sensor comprises a thermocouple.

22. A method, comprising:
flowing reagent through at least one of a reagent fluidic line or a common fluidic line and toward a flow cell assembly;
determining a temperature associated with the reagent fluidic line or the common fluidic line;
comparing the determined temperature to a reference temperature; and
in response to the determined temperature being outside of a threshold of the reference temperature, changing a temperature of the reagent as the reagent is flowing through the at least one of the reagent fluidic line or the common fluidic line.

23. The method of claim 22, wherein changing the temperature of the reagent comprises heating the at least one of the reagent fluidic line or the common fluidic line.

24. The method of claim 23, wherein heating the at least one of the reagent fluidic line or the common fluidic line comprises heating the common fluidic line and substantially not heating the reagent fluidic line.

25. The method of claim 22, wherein the heating comprises heating using at least one of a flexible heater, an infrared heater, and/or an LED heater.

26-63. (canceled)
